(19) United States
(12) Patent Application Publication
(10) Pub. No.: US 2013/0262189 A1
(43) Pub. Date: Oct. 3, 2013

(54) ANALYZING METERED COST EFFECTS OF DEPLOYMENT PATTERNS IN A NETWORKED COMPUTING ENVIRONMENT

(71) Applicants: Jason L. Anderson, San Jose, CA (US); Gregory J. Boss, Saginaw, MI (US); Jeffrey L. Coveyduc, San Jose, CA (US); Shaun T. Murakami, San Jose, CA (US); John Reif, Redwood City, CA (US); Animesh Singh, Santa Clara, CA (US)

(72) Inventors: Jason L. Anderson, San Jose, CA (US); Gregory J. Boss, Saginaw, MI (US); Jeffrey L. Coveyduc, San Jose, CA (US); Shaun T. Murakami, San Jose, CA (US); John Reif, Redwood City, CA (US); Animesh Singh, Santa Clara, CA (US)

(73) Assignee: International Business Machines Corporation, Armonk, NY (US)

(21) Appl. No.: 13/437,119

(22) Filed: Apr. 2, 2012

(51) Int. Cl. G06Q 40/00

(52) U.S. Cl. 705/7.36

(57) ABSTRACT

Embodiments of the present invention provide an approach for analyzing operating costs (e.g., metered cost effects) for deployment patterns (and changes thereto) in a networked computing environment. In a typical embodiment, a deployment pattern for the networked computing environment is identified. The deployment pattern may comprise a set of components arranged in a network topology. Moreover, the set of components may be associated with a set of policies (e.g., stored in a computer memory medium and/or computer storage device). A cost analysis algorithm(s) may then be selected for the deployment pattern. The selected algorithm(s) may then be applied (e.g., to the deployment pattern and/or network computing environment) to analyze the operating costs of the deployment pattern.

### TECHNICAL FIELD

In general, embodiments of the present invention relate to operating cost analysis for computing infrastructures. Specifically, embodiments of the present invention relate to an approach for analyzing operating costs (e.g., metered cost effects) for deployment patterns/topologies in a networked computing environment (e.g., a cloud computing environment).

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

Cloud services may be rendered through dynamic infrastructure provisioning. For example, within a relatively static hardware pool, operating systems and applications may be deployed and reconfigured to meet dynamic customer computational demands. Within a cloud environment's boundaries, images may be installed and overwritten, Internet Protocol (IP) addresses may be modified and real and virtual processors may be allocated to meet changing business needs. Challenges may exist, however, in determining an impact of various changes (e.g., policy and/or service level agreement (SLA) changes) on operating costs for a given infrastructure.

### SUMMARY

In general, embodiments of the present invention provide an approach for analyzing operating costs (e.g., metered cost effects) for deployment patterns (and changes thereto) in a networked computing environment. In a typical embodiment, a deployment pattern for the networked computing environment is identified. The deployment pattern may comprise a set of components arranged in a network topology. Moreover, the set of components may be associated with a set of policies (e.g., stored in a computer memory medium and/or computer storage device). A cost analysis algorithm may then be selected for the deployment pattern. The cost analysis algorithm may comprise at least one of the following: an association of component policy values to actual resource consumption of the deployment pattern in the networked computing environment; an association of component policy values to a target cost for implementing the deployment pattern; a determination of overall cost of implementing the deployment pattern based on the set of components, the set of policies, and a set of interrelationships between the set of components; and/or a determination of real-time/actual operating costs associated with the deployment pattern. The selected algorithm(s) may then be applied (e.g., to the deployment pattern and/or network computing environment) to analyze the operating costs of the deployment pattern.

A first aspect of the present invention provides a computer-implemented method for analyzing operating costs in a networked computing environment, comprising: identifying a deployment pattern for the networked computing environment, the deployment pattern comprising a set of components arranged in a network topology, and the set of components being associated with a set of policies stored in a computer memory medium; selecting a cost analysis algorithm for the deployment pattern, the cost analysis algorithm comprising at least one of the following: an association of component policy values to actual resource consumption of the deployment pattern in the networked computing environment; an association of component policy values to a target cost for implementing the deployment pattern; a determination of overall cost of implementing the deployment pattern based on the set of components, the set of policies, and a set of interrelationships between the set of components; a determination of live operating costs associated with the deployment pattern; and applying the cost analysis algorithm to analyze the operating costs of the deployment pattern.

A second aspect of the present invention provides a system for analyzing operating costs in a networked computing environment, comprising: a memory medium comprising instructions; a bus coupled to the memory medium; and a processor coupled to the bus that when executing the instructions causes the system to: identify a deployment pattern for the networked computing environment, the deployment pattern comprising a set of components arranged in a network topology, and the set of components being associated with a set of policies stored in a computer memory medium; select a cost analysis algorithm for the deployment pattern, the cost analysis algorithm comprising at least one of the following: an association of component policy values to actual resource consumption of the deployment pattern in the networked computing environment; an association of component policy changes to a target cost for implementing the deployment pattern; a determination of overall cost of implementing the deployment pattern based on the set of components, a set of policies associated with the set of components, and interrelationships between the set of components; a determination of live operating costs associated with the deployment pattern; and apply the cost analysis algorithm to analyze the operating costs of the deployment pattern.

A third aspect of the present invention provides a computer program product for analyzing operating costs in a networked computing environment, the computer program product comprising a computer readable storage media, and program instructions stored on the computer readable storage media, to:

identify a deployment pattern for the networked computing environment, the deployment pattern comprising a set of components arranged in a network topology, and the set of components being associated with a set of policies stored in a computer memory medium; select a cost analysis algorithm for the deployment pattern, the cost analysis algorithm comprising at least one of the following: an association of component policy values to actual resource consumption of the deployment pattern in the networked computing environment; an association of component policy changes to a target cost for implementing the deployment pattern; a determination of overall cost of implementing the deployment pattern based on the set of components, a set of policies associated with the set of components, and interrelationships between the set of components; a determination of live operating costs associated with the deployment pattern; and apply the cost analysis algorithm to analyze the operating costs of the deployment pattern.

A fourth aspect of the present invention a method for deploying a system for analyzing operating costs in a networked computing environment, comprising: providing a computer infrastructure being operable to: identify a deployment pattern for the networked computing environment, the deployment pattern comprising a set of components arranged in a network topology, and the set of components being associated with a set of policies stored in a computer memory medium; select a cost analysis algorithm for the deployment pattern, the cost analysis algorithm comprising at least one of the following: an association of component policy costs to actual resource consumption of the deployment pattern in the networked computing environment; an association of component policy values to a target cost for implementing the deployment pattern; a determination of overall cost of implementing the deployment pattern based on the set of components, a set of policies associated with the set of components, and interrelationships between the set of components; a determination of live operating costs associated with the deployment pattern; and apply the cost analysis algorithm to analyze the operating costs of the deployment pattern.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a system diagram according to an embodiment of the present invention.

FIG. 5 depicts a user interface according to an embodiment of the present invention.

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for analyzing operating costs (e.g., metered cost effects) for deployment patterns (and changes thereto) in a networked computing environment. In a typical embodiment, a deployment pattern for the networked computing environment is identified. The deployment pattern may comprise a set of components arranged in a network topology. Moreover, the set of components may be associated with a set of policies (e.g., stored in a computer memory medium and/or computer storage device). A cost analysis algorithm may then be selected for the deployment pattern. The cost analysis algorithm may comprise at least one of the following: an association of component policy values to actual resource consumption of the deployment pattern in the networked computing environment; an association of component policy values to a target cost for implementing the deployment pattern; a determination of overall cost of implementing the deployment pattern based on the set of components, the set of policies, and a set of interrelationships between the set of components; and/or a determination of real-time/actual operating costs associated with the deployment pattern. The selected algorithm(s) may then be applied (e.g., to the deployment pattern and/or network computing environment) to analyze the operating costs of the deployment pattern.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (laaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

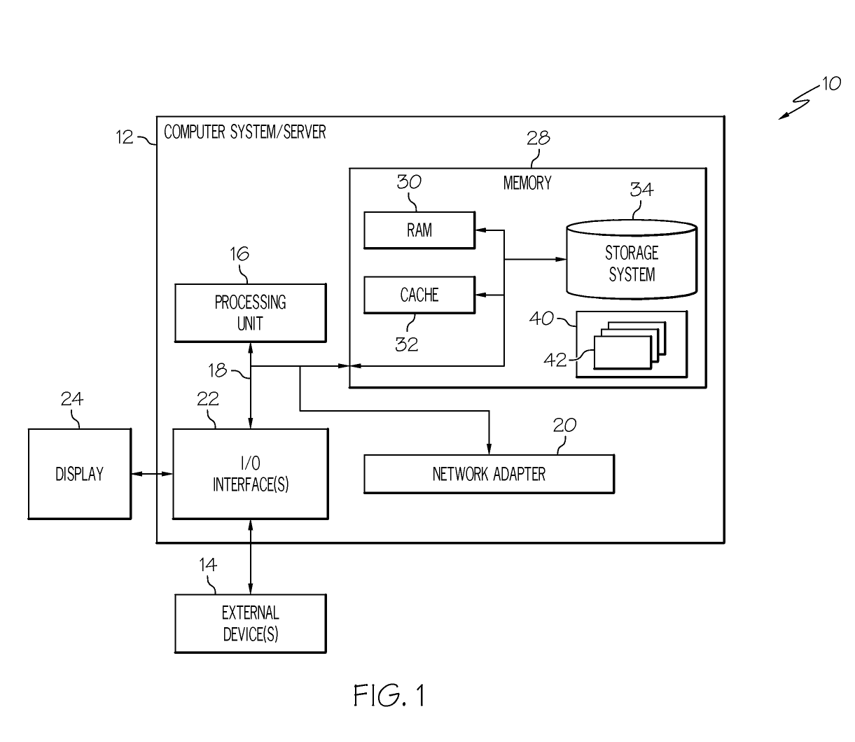

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

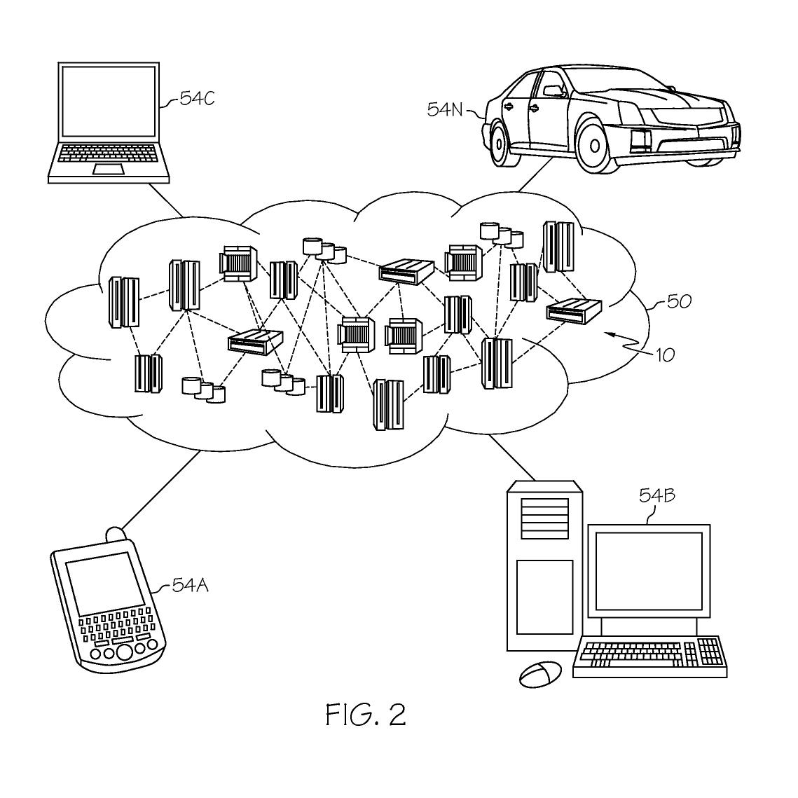

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web brow4

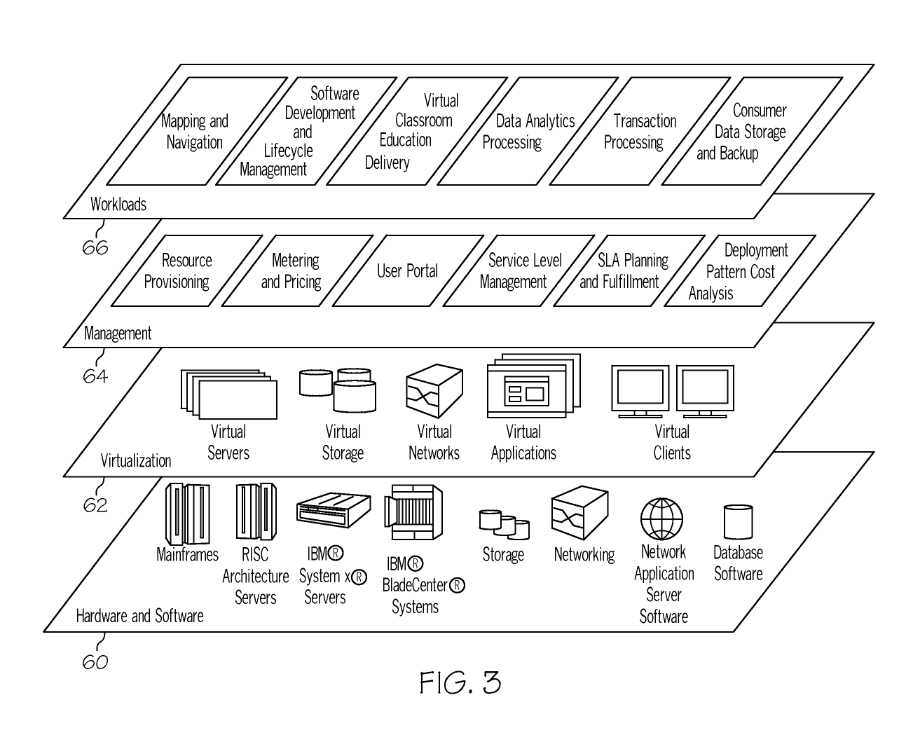

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System x® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is deployment pattern cost analysis, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and consumer data storage and backup. As mentioned above, all of the foregoing examples described with respect to FIG. 3 are illustrative only, and the invention is not limited to these examples.

It is understood that all functions of the present invention as described herein typically may be performed by the deployment pattern cost analysis functionality of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

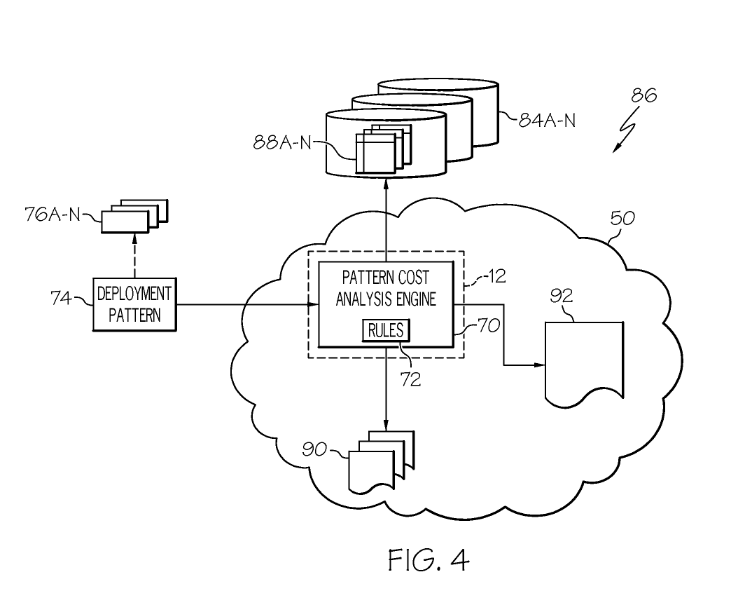

Referring now to FIG. 4, a system diagram describing the functionality discussed herein according to an embodiment of the present invention is shown. It is understood that the teachings recited herein may be practiced within any type of networked computing environment 86 (e.g., a cloud computing environment 50). A stand-alone computer system/server 12 is shown in FIG. 4 for illustrative purposes only. In the event the teachings recited herein are practiced in a networked computing environment 86, each client need not have a deployment pattern cost analysis engine (engine 70). Rather, engine 70 could be loaded on a server or server-capable device that communicates (e.g., wirelessly) with the clients to deployment pattern cost analysis. Regardless, as depicted, engine 70 is shown within computer system/server 12. In general, engine 70 can be implemented as program/utility 40 on computer system 12 of FIG. 1 and can enable the functions recited herein. As further shown, engine 70 (in one embodiment) comprises a rules and/or computational engine that processes a set (at least one) of rules/logic 72 and/or provides deployment pattern cost analysis hereunder.

As indicated above, embodiments of the invention provide an approach for analyzing cloud economics/costs using deployment patterns, policies and/or runtime characteristics. As will be further discussed, the approach utilizes multiple methods/algorithms for analyzing/driving overall cloud deployment costs. One method maps basic cost appraisals to each component in a deployment pattern/topology. Another method allows users to specify a target cost for their deployment that the system then uses to generate a prioritized list of paths to achieve a stated goal. Another method calculates a total cost of a deployment including interrelationships of characteristics, policies, and/or attributes. Yet another method provides a runtime approach to monitoring live costs associated with a running application's policies that trigger a policy modification request with associated cost. It should be appreciated that these methods need not be mutually exclusive. Rather, they could be used in combination with one another. However, these methods/algorithms can be described in further detail as follows:
a method/algorithm to associate component policy values to actual resource consumption (e.g., how a scaling policy value affects a amount of network traffic);
a method/algorithm to return recommended policy changes in response to a consumer's request to achieve a target cost;
a method/algorithm to determine the overall cost of a deployment based on a sum of components, associated policies, attributes, and an expected “added value” from their relationships; and/or
a method/algorithm that provides a runtime approach to monitoring live costs associated with a running application's policies that trigger a policy modification request with associated cost.

Along these lines, engine 70 may perform multiple functions similar to a general-purpose computer. Specifically, among other functions, engine 70 may (among other things): identify a deployment pattern 74 for the networked computing environment 86, the deployment pattern 74 comprising a set of components 76A-N arranged in a network topology, and the set of components 76A-N being associated with a set of policies 88A-N stored in a computer memory medium 28 of FIG. 1 and/or a set of computer storage devices 84A-N; select a cost analysis algorithm 90 for the deployment pattern 74 (as indicated above, the cost analysis algorithm comprising at least one of the following: an association of component policy values to actual resource consumption (e.g., meta-data that associates the component policy values with the set of components) of the deployment pattern in the networked computing environment; an association of component policy changes to a target cost for implementing the deployment pattern (e.g., comprising a list of suggested changes to the set of policies associated with the set of components needed to achieve the target cost); a determination of overall cost of implementing the deployment pattern based on the set of components, the set of policies, and a set of interrelationships between the set of components (e.g., a summation of a cost for implementing the set of components and a cost for implementing the set of policies associated with the set of component); and/or a determination of live operating costs (e.g., real-time costs) associated with the deployment pattern; apply the cost analysis algorithm to analyze the operating costs of the deployment pattern; generate a report 92 or the like with analysis results; determine whether the live operating costs are consistent with terms set forth in the set of policies; and/or modify the deployment pattern based on the analysis of the operating cost.

Along these lines, it is understood that various elements of a computing infrastructure can have costs subject to the analysis hereunder. The following describes a non-exhaustive list of potential elements for which costs may be associated:
Scaling Policies
   Scale out factor—number of additional nodes, maximum number of nodes, minimum number of nodes, etc.
   Scale up factor—number of CPU units to add
   Trigger threshold(s)—responses time, etc
Security Policies
   Firewalls—number of ports active
   Anti-virus algorithms
   Routing rules
   Proxy configurations
Java®/Java Virtual Machine (JVM®) Policies (Java and JVM are trademarks of Oracle America, Inc. in the United States and/or other countries)
   Heap size
Network Policies
   IP addresses
   Virtual Local Area Networks (VLANS)
   Virtual Private Network (VPNs)
   Switch configurations
   Traffic shaping (e.g., throughput)
Storage/Disk Policies
   Disk Size (e.g., of a node)
   Persistent storage—size and duration
   Data archiving
   Data backup
License Policies
   Software
   Hardware
   Appliance
Leasing Policies
   Time charges for resources
Isolation Policies
   Dedication of resources

As summarized above, embodiments of the present invention provide multiple cost analysis methods/algorithms. These method/algorithms will now be described in greater detail below:

### A. A Method/Algorithm to Associate Component Policy Costs to Actual Resource Consumption

This method/algorithm describes how the costs for components would be defined and associated with the policies to instantiate a given component including information about the consumption of resources needed for the system.
1. Components in the system are represented by meta-data that is stored in a persistent memory medium and used during run time to make policy based decisions;
2. New meta-data would be added to the system that would associate cost with a component type and/or policy value;
3. The component cost associated with the component could be set at the various scopes defined for the system (e.g., a component at one scope may have a different cost value than the same component at a different scope or different part of the cloud system);
4. The cost values corresponding to a component or policy would be represented in meta-data and used by the system to calculate cost of an instantiated component. For example, a cost of a component may be specified by a customer, or be estimated based on historical data and/or user-provided input such runtime characteristics; and
5. The cost may be associated with constituent parts or resources that make up a component (i.e. CPU, memory, disk are parts that make up a computer and each could have costs that contribute to the overall cost of that component).

### B. A Method/Algorithm to Return Recommended Policy Changes in Response to a Consumers Request to Achieve a Target Cost

1. Create a topology to deploy;
2. A consumer of the cloud specifies a given target cost for the requested deployment of resources;
3. The system calculates the total cost for the requested deployment;
4. If the total cost is higher than the target, the system generates suggestions to better achieve the target (e.g., reduce resources, etc.);
5. The consumer then is provided this prioritized list of suggestions based on the most important workload characteristics (e.g. fault tolerance, high performance, etc.). For example, the system could prioritize components in a way to achieve a target cost and/or customer-specified requirements. In the case of the former, if the target cost is being exceeded, the system couple put a higher priority on cost-saving components and/or procedures such as reducing data replication; and
6. The consumer then chooses one or more of the suggestions to achieve his/her goal.

### C. A Method/Algorithm to Determine the Overall Cost of a Deployment Based on the Sum of Components and Embodied Policies Defined in a Topology/Pattern

1. Calculate a base cost of all the components;
2. Analyze the characteristics, attributes and interrelationships of and between the components and assign secondary cost derivatives. For example, based on historical data of components and instances needed, an estimated cost can be calculated; and
3. Sum the total costs for all previous steps.
   D. a Method/Algorithm to Monitor Costs in Real-Time as Defined by a Cloud Topology/Pattern to Ensure that a Deployment Remains Consistent with Policies and Attributes
1. The system monitors the deployment to ensure that policies and attributes are within bounds;
2. If at any time the policies are met and characteristics need to change feedback cost to the user; and
3. The user then makes a choice to modify the policies according to the system's suggestions or to maintain the current policies. For example, at runtime, it may be determined whether the policy will be complied with. If the policy will be exceeded, the customer can be asked for additional cost revenue. Alternatively, the system may determine cost-saving actions such as reducing data replication, etc. so that the policy is complied with.

It is understood that there may be existing topologies in a catalog that are free for use. Any changes to these free topologies may be an incremental cost to the user.

### Example Embodiment

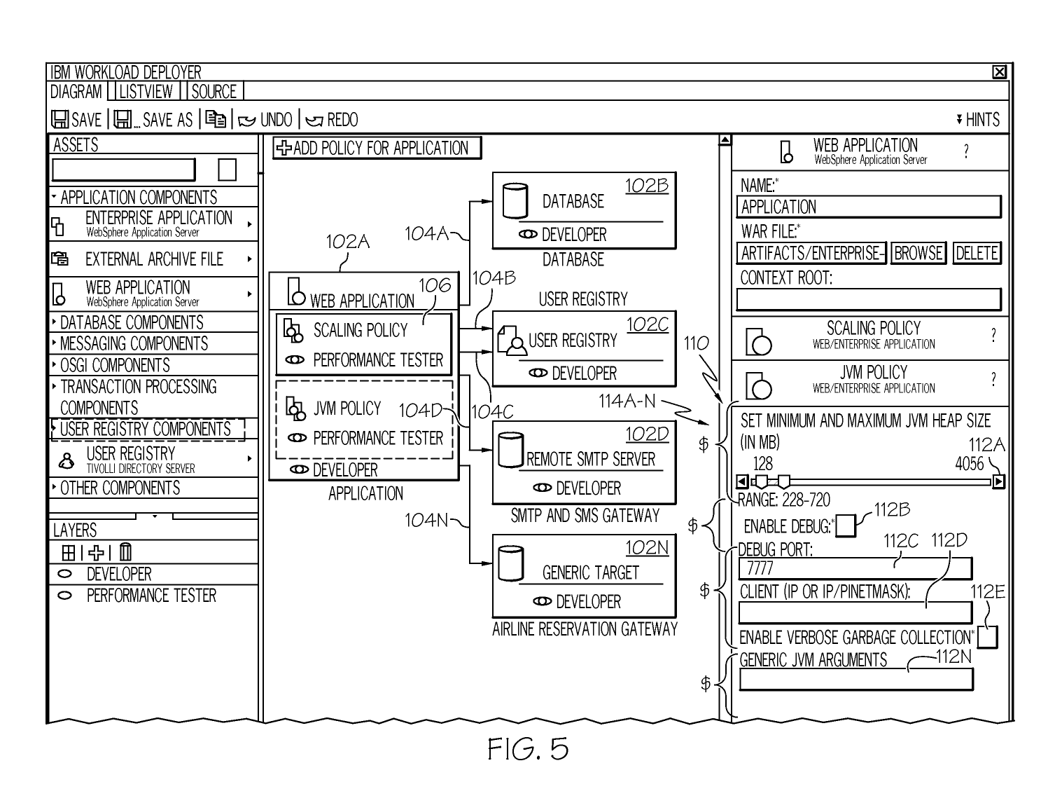

As policies are changed by the end user, the component cost for that policy change is reflected via a user interface. An example of such an interface 100 is shown in FIG. 5. As depicted, components 102A-N are graphically shown and connected to one another via interrelationships/connections 104A-N. As further shown, a particular policy 106 has been selected/identified for component 102A. As a result, a policy attribute window 110 may be displayed having various attributes 112A-N. As the values of attributes 112A-N are set and/or changed, cost data 114A-N could be displayed accordingly. The cost data 114A-N may comprise pricing, rates, changes in overall costs, etc.

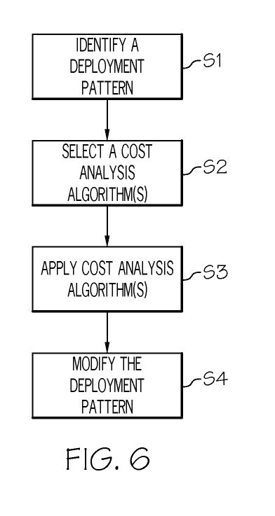

Referring now to FIG. 6, a method flow diagram according to the present invention is shown. In step S1, a deployment pattern is identified for a networked computing environment. As described above, the deployment pattern may comprise a set of components arranged in a network topology, and the set of components may be associated with a set of policies stored in a computer memory medium. In step S2, a cost analysis algorithm (set forth above) may be selected for the deployment pattern. In step S3, the cost analysis algorithm is applied (e.g., to the deployment pattern) to analyze the operating costs of the deployment pattern. In step S4, the deployment pattern may be modified to achieve a specific goal (e.g., a target cost).

While shown and described herein as a deployment pattern cost analysis solution, it is understood that the invention further provides various alternative embodiments. For example, in one embodiment, the invention provides a computer-readable/useable medium that includes computer program code to enable a computer infrastructure to provide deployment pattern cost analysis functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide deployment pattern cost analysis functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for deployment pattern cost analysis. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A computer-implemented method for analyzing operating costs in a networked computing environment, comprising:
a computing device identifying a deployment pattern for the networked computing environment, the deployment pattern comprising a set of components arranged in a network topology, and the set of components being associated with a set of policies stored in a computer memory medium;
the computing device selecting a cost analysis algorithm for the deployment pattern, the cost analysis algorithm comprising:
an association of component policy changes to a target cost for implementing the deployment pattern, the association of component policy changes to the target cost comprising a prioritized list of a plurality of suggested changes to the set of policies needed to achieve the target cost;
the computing device applying the cost analysis algorithm to analyze the operating costs of the deployment pattern and generate the prioritized list of a plurality of suggested changes to the set of policies needed to achieve the target cost.

2. The computer-implemented method of claim 1, the association of component policy values to actual resource consumption comprising meta-data that associates the component policy values with the set of components.

3. The computer-implemented method of claim 1, the cost analysis algorithm further comprising at least one of the following:
an association of component policy values to actual resource consumption of the deployment pattern in the networked computing environment;
a determination of overall cost of implementing the deployment pattern based on the set of components, the set of policies, and a set of interrelationships between the set of components; and
a determination of live operating costs associated with the deployment pattern.

4. The computer-implemented method of claim 1, the overall cost comprising a summation of a cost for implementing the set of components and a cost for implementing the set of policies.

5. The computer-implemented method of claim 1, the live operating costs comprising real-time costs, the method further comprising the computing device determining whether the live operating costs are consistent with terms set forth in the set of policies.

6. The computer-implemented method of claim 1, further comprising the computing device modifying the deployment pattern based on the analysis of the operating costs.

7. The computer-implemented method of claim 1, the networked computing environment comprising a cloud computing environment.

8. A system for analyzing operating costs in a networked computing environment, comprising:
a memory medium comprising instructions;
a bus coupled to the memory medium; and
a processor coupled to the bus that when executing the instructions causes the system to:
identify a deployment pattern for the networked computing environment, the deployment pattern comprising a set of components arranged in a network topology, and the set of components being associated with a set of policies stored in a computer memory medium;
select a cost analysis algorithm for the deployment pattern, the cost analysis algorithm comprising:
an association of component policy changes to a target cost for implementing the deployment pattern, the association of component policy changes to the target cost comprising a prioritized list of a plurality of suggested changes to the set of policies needed to achieve the target cost; and
apply the cost analysis algorithm to analyze the operating costs of the deployment pattern and generate the prioritized list of a plurality of suggested changes to the set of policies needed to achieve the target cost.

9. The system of claim 8, the association of component policy values to actual resource consumption comprising meta-data that associates the component policy values with the set of components.

10. The system of claim 8, the cost analysis algorithm further comprising at least one of the following:
an association of component policy values to actual resource consumption of the deployment pattern in the networked computing environment;
a determination of overall cost of implementing the deployment pattern based on the set of components, the set of policies, and a set of interrelationships between the set of components; and
a determination of live operating costs associated with the deployment pattern.

11. The system of claim 8, the overall cost comprising a summation of a cost for implementing the set of components and a cost for implementing the set of policies associated with the set of components.

12. The system of claim 8, the live operating costs comprising real-time costs, and the memory medium further comprising instructions for causing the system to determine whether the live operating costs are consistent with terms set forth in the set of policies.

13. The system of claim 8, the memory medium further comprising instructions for causing the system to modify the deployment pattern based on the analysis of the operating costs.

14. The system of claim 8, the networked computing environment comprising a cloud computing environment.

15. A computer program product for analyzing operating costs in a networked computing environment, the computer program product comprising a non-transitory computer readable storage media, and program instructions stored on the computer readable storage media, to:
identify a deployment pattern for the networked computing environment, the deployment pattern comprising a set of components arranged in a network topology, and the set of components being associated with a set of policies stored in a computer memory medium;
select a cost analysis algorithm for the deployment pattern, the cost analysis algorithm comprising:
an association of component policy changes to a target cost for implementing the deployment pattern, the association of component policy changes to the target cost comprising a prioritized list of a plurality of suggested changes to the set of policies needed to achieve the target cost; and
apply the cost analysis algorithm to analyze the operating costs of the deployment pattern and generate the prioritized list of a plurality of suggested changes to the set of policies needed to achieve the target cost.

16. The computer program product of claim 15, the association of component policy values to actual resource consumption comprising meta-data that associates the component policy values with the set of components.

17. The computer program product of claim 15, the cost analysis algorithm further comprising at least one of the following:
an association of component policy values to actual resource consumption of the deployment pattern in the networked computing environment;
a determination of overall cost of implementing the deployment pattern based on the set of components, the set of policies, and a set of interrelationships between the set of components; and
a determination of live operating costs associated with the deployment pattern.

18. The computer program product of claim 15, the overall cost comprising a summation of a cost for implementing the set of components and a cost for implementing the set of policies associated with the set of components.

19. The computer program product of claim 15, the live operating costs comprising real-time costs, and the computer readable storage media further comprising instructions to determine whether the live operating costs are consistent with terms set forth in the set of policies.

20. The computer program product of claim 15, the non-transitory computer readable storage media further comprising instructions to modify the deployment pattern based on the analysis of the operating costs.

21. The computer program product of claim 15, the networked computing environment comprising a cloud computing environment.

22. A method for deploying a system for analyzing operating costs in a networked computing environment, comprising:
a computer system to identify a deployment pattern for the networked computing environment, the deployment pattern comprising a set of components arranged in a network topology, and the set of components being associated with a set of policies stored in a computer memory medium;
the computer system to select a cost analysis algorithm for the deployment pattern, the cost analysis algorithm comprising:
an association of component policy changes to a target cost for implementing the deployment pattern, the association of component policy changes to the target cost comprising a prioritized list of suggested changes to the set of policies needed to achieve the target cost;
the computer system to apply the cost analysis algorithm to analyze the operating costs of the deployment pattern and generate the prioritized list of a plurality of suggested changes to the set of policies needed to achieve the target cost.
